(19) United States
(12) Patent Application Publication
(10) Pub. No.: US 2014/0310051 A1
(43) Pub. Date: Oct. 16, 2014

(54) Methods and Apparatus for Project Portfolio Management

(71) Applicant: International Business Machines Corporation, Armonk, NY (US)

(72) Inventors: Fan Jing Meng, Beijing (CN); Peri Tarr, Briarcliff Manor, NY (US); Xin Zhou, Beijing (CN)

(73) Assignee: International Business Machines Corporation, Armonk, NY (US)

(21) Appl. No.: 13/970,775

(22) Filed: Aug. 20, 2013

Related U.S. Application Data
(63) Continuation of application No. 13/861,803, filed on Apr. 12, 2013.

(51) Int. Cl. G06Q 10/06

(52) U.S. Cl. CPC G06Q 10/06315
USPC 705/7.25

(57) ABSTRACT

Systems and techniques for optimization of project portfolio. A set of original proposals, including at least one original proposal allowing for a choice between two or more equivalent sets of resource requirements, are translated into a set of equivalent substitute proposals ensured by translated logical dependencies among them. The set of substitute proposals is optimized and a solution provided by the optimization is translated into a solution in terms of the original proposals.

### CROSS-REFERENCE TO RELATED APPLICATIONS

This patent application is a continuation of U.S. patent application Ser. No. 13/861,803, filed on Apr. 12, 2013, which is incorporated herein by reference in its entirety to provide continuity of disclosure.

### FIELD OF THE INVENTION

One or more embodiments of the present invention relate generally to systems and techniques for project portfolio management. More particularly, the invention relates to improved mechanisms for distinguishing between competing proposals that include equivalent requirements.

### BACKGROUND

Enterprises undertake activities to achieve their various objectives, and such activities are typically organized into projects. A group of projects to be undertaken by an enterprise, or the total of all projects being undertaken or considered by an enterprise, may be referred to as a project portfolio, and the optimization and selection of project proposals, and the management of projects that are underway, is referred to as project portfolio management. A well-defined project is defined at its inception so as to achieve specified objectives using specified resources. Proposals to accomplish a specific set of objectives may be selected from among competing proposals based on the resources they require and the costs of those resources. Resources may be defined in terms of materials, labor, time, and other elements, and optimization may be performed to identify combinations that will achieve the desired objectives at the lowest resource cost. The optimization of project proposals may be undertaken by any of a number of mechanisms, many of which are standardized and convenient for use. Project proposals may be evaluated based at least in part on their impact on the total project portfolio capacity of an enterprise, that is, the total resources available for projects.

### SUMMARY

In one embodiment of the invention, a method comprises translating an original proposal directed toward achieving an objective into a set of at least two substitute proposals, in a case in which the original proposal presents a choice between at least two equivalent sets of resource requirements. The translation yields one proposal for each set of resource requirements. The method further comprises performing optimization on a set of proposals including the set of substitute proposals, to yield an optimized solution, wherein the optimized solution is represented in terms including at least one of the substitute proposals. The method further comprises translating the optimized solution to a set of proposals taken from the original proposals.

In another embodiment of the invention, a method comprises translating an original proposal directed toward achieving an objective into a set of at least two substitute proposals, in a case in which the original proposal presents a choice between at least two equivalent sets of resource requirements. The translation yields one proposal for each set of resource requirements. The method further comprises performing optimization on a set of proposals including the set of substitute proposals, to yield an optimized solution. The optimized solution is represented in terms including at least one of the substitute proposals.

In another embodiment of the invention, a method comprises performing optimization on a set of proposals to yield an optimized solution. The set of proposals comprises a set of substitute proposals resulting from translation of an original proposal into the set of substitute proposals. The original proposal presents a choice between at least two equivalent sets of resource requirements and wherein the set of substitute proposals comprises one substitute proposal for each set of resource requirements. The method further comprises translating the optimized solution to a set of proposals taken from the original proposals.

In another embodiment of the invention, an apparatus comprises at least one processor and memory storing computer program code. The memory storing the computer program code is configured to, with the at least one processor, cause the apparatus to at least translate an original proposal directed toward achieving an objective into a set of at least two substitute proposals, in a case in which the original proposal presents a choice between at least two equivalent sets of resource requirements. The translation yields one proposal for each set of resource requirements. Optimization is performed on a set of proposals including the set of substitute proposals, to yield an optimized solution, wherein the optimized solution is represented in terms including at least one of the substitute proposals. The optimized solution is translated to a set of proposals taken from the original proposals.

In another embodiment of the invention, a computer readable medium stores a program of instructions. Execution of the program of instructions by a processor configures an apparatus to at least perform optimization on a set of proposals to yield an optimized solution. The set of proposals comprises a set of substitute proposals resulting from translation of an original proposal into the set of substitute proposals. The original proposal presents a choice between at least two equivalent sets of resource requirements and wherein the set of substitute proposals comprises one substitute proposal for each set of resource requirements. The optimized solution is translated to a set of proposals taken from the original proposals.

In another embodiment of the invention, a computer readable medium stores a program of instructions. Execution of the program of instructions by a processor configures an apparatus to at least translate an original proposal directed toward achieving an objective into a set of at least two substitute proposals, in a case in which the original proposal presents a choice between at least two equivalent sets of resource requirements. The translation yields one proposal for each set of resource requirements. Optimization is performed on a set of proposals including the set of substitute proposals, to yield an optimized solution, wherein the optimized solution is represented in terms including at least one of the substitute proposals. The optimized solution is translated to a set of proposals taken from the original proposals.

In another embodiment of the invention, a computer readable medium stores a program of instructions. Execution of the program of instructions by a processor configures an apparatus to at least perform optimization on a set of proposals to yield an optimized solution. The set of proposals comprises a set of substitute proposals resulting from translation of an original proposal into the set of substitute proposals. The original proposal presents a choice between at least two equivalent sets of resource requirements and wherein the set of substitute proposals comprises one substitute proposal for each set of resource requirements. The optimized solution is translated to a set of proposals taken from the original proposals.

### BRIEF DESCRIPTION OF THE SEVERAL VIEWS OF THE DRAWINGS

FIGS. 1 and 2 illustrate processes according to embodiments of the present invention;

FIG. 3 illustrates components according to embodiments of the present invention;

FIGS. 4-6 illustrate operations carried out according to an embodiment of the present invention; and

FIG. 7 illustrates elements according to an embodiment of the present invention.

### DETAILED DESCRIPTION

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the present invention recognize that evaluation of competing proposals to achieve a specified set of objectives may involve the evaluation of alternative proposals involving alternative sets of requirements that are equivalent between alternatives. Embodiments of the invention further recognize that the use of an enterprise's standard or preferred optimizer may be desired, but special configuration of optimizers to address equivalent sets of requirements is not common. Embodiments of the invention further recognize that equivalent sets of requirements may create differences in the overall cost and impact of alternative proposals, and that addressing these differences in selection can lead to a more informed choice between competing proposals.

Proposals may be evaluated based on the resource requirements they present, evaluated in terms of resource constraints. For example, a proposal may require “tester” resources of 30 person-months and “Java developer resources of 50 person-months,” and so on. Another proposal may require “tester” resources of 25 person-months and “C++ developer” resources of 45 person months, and so on. In an example, total available “tester” resources in a portfolio may be 70 person months, and total available “C++ developer” resources may be 80 person-months.

In some cases, a proposal may present two or more alternative equivalent resource requirements—that is, a category of requirements of a proposal may be satisfied in any of two or more different ways. For example, “testing” requirements of a particular proposal may be able to be satisfied either with a tester experienced in performance testing with LoadRunner or a person experienced in performance testing with QALoader.

In one or more embodiments, therefore, the invention provides mechanisms to process proposals with equivalent resource requirements before optimization, and to process solutions returned by optimization so that the solutions are presented in to is of the original proposals.

In one or more embodiments of the invention, therefore, proposals with equivalent resource requirements may be translated into substitute proposals and their interdependencies. These substitutes may then be processed using a standard optimizer that is not specially adapted to address equivalent requirements. Further translation may then be performed to translate an optimal solution returned by the optimizer into the terms of the original proposals.

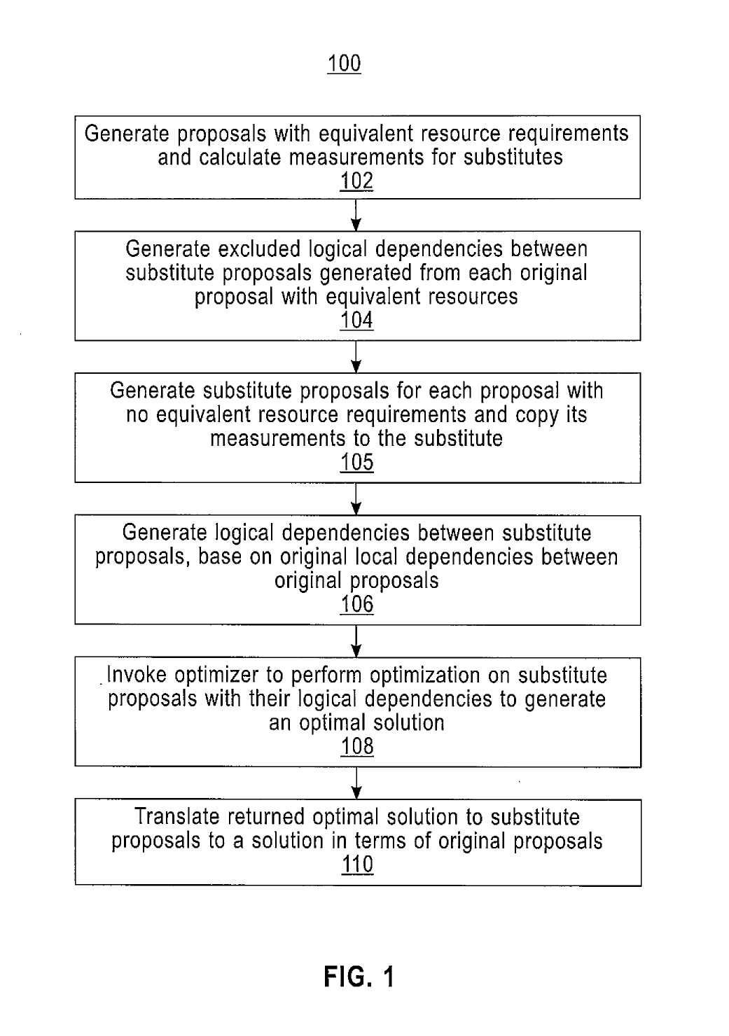

FIG. 1 illustrates a process 100 according to an embodiment of the present invention. Steps 102-106 achieve translation of proposals with equivalent resource requirements into substitutes. At step 102, proposals with equivalent resource requirements are generated and measurements are calculated for generated substitute elements. At step 104, excluded logical dependencies between substitute proposals are generated. At step 105, proposals with no equivalent resource requirements are generated and measurements are copied from original proposals to the substitute proposals. At step 106, logical dependencies between substitute proposals are generated based on original logical dependencies.

At step 108, an optimizer is invoked to perform optimization on the substitute proposals with their logical dependencies to generate an optimal solution. At step 110, the returned optimal solution to the substitute proposals is translated to a solution in terms of the original proposals.

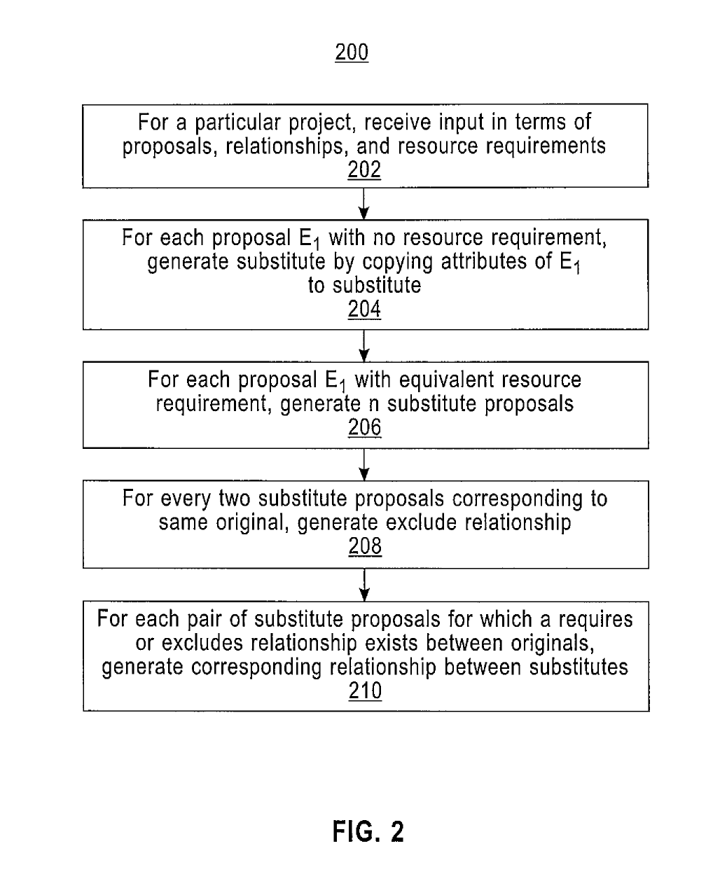

FIG. 2 illustrates a process 200 according to an embodiment of the present invention. The process 200 may be thought of as a more detailed mechanism for accomplishing the result achieved by the process of FIG. 1, which provides a more general overview. The process 200 generates substitute proposals and defines their interrelationships, with the substitute proposal for an original with no resource requirements being the same as the original.

At step 202, for a particular project, expressed in terms of a set of objectives to be achieved, input is received in terms of proposals, their relationships, and their resource requirements. At step 204, for each proposal Eᵢ with no equivalent resource requirement, a substitute proposal is generated by copying the attributes of Eᵢ to the attributes of the substitute proposal.

At step 206, for each proposal Eᵢ with an equivalent resource requirement, which may suitably be defined as members of a set {ERᵢ1, ERᵢ2, . . . , ERᵢn}, n substitute proposals may be generated, suitably defined as members of a set {SERᵢ1, SERᵢ2, . . . , SERᵢn}with attributes being calculated for each substitute proposal based on the original proposal attributes. At step 208, for every two substitute proposals corresponding to the same original proposal, an exclude relationship is generated between the substitute proposals. At step 210, for each pair of substitute proposals (SEᵢ, SEⱼ), for which a requires or excludes relationship exists between their original proposals, a corresponding require or exclude relationship is generated between the substitutes.

At step 212, an optimizer is invoked to process the input as translated by the steps 204-210. If no optimal solution can be achieved, the process proceeds to step 214 and a notification is presented that no optimal solution is available. If an optimal solution can be achieved, the process proceeds to step 216 and the optimal solution is translated to an optimal solution presented in terms of the original proposals. At step 218, the optimal solution is returned.

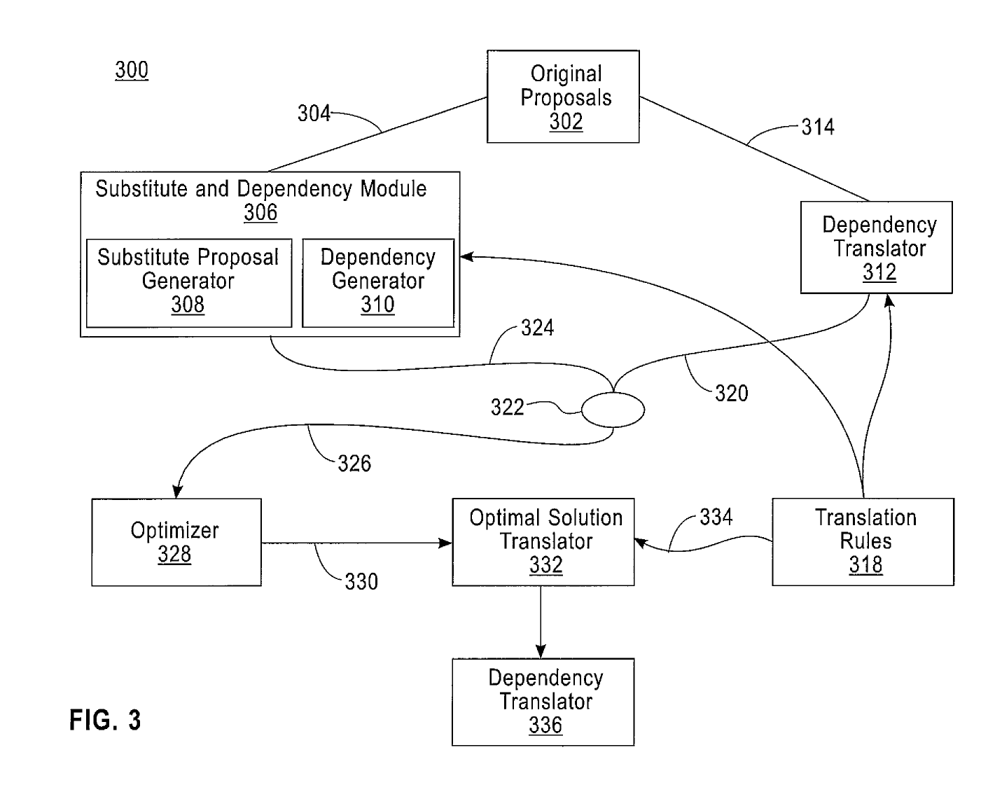

FIG. 3 illustrates a functional block diagram 300 according to an embodiment of the present invention. The diagram 300 illustrates a set 302 of original proposals, providing original proposal information 304 to a substitute and dependency module 306. The module 306 comprises a substitute proposal generator 308, which provides information to a dependency generator 310. A dependency translator 312 receives relationship information 314 from the set 302 of original proposals, and substitute proposals from the substitute proposal generator 308, as well as translation rules 316 from a set 318 of translation rules. The dependency translator 312 passes dependency information 320 to a combiner 322, which combines the dependency information 320 with substitute proposal information 324 to generate information 326 identifying substitute proposals with relationships. The substitute proposal with relationship information 326 is delivered to an optimizer 328, which may be a standard optimizer that is not specially adapted to take into account equivalencies between requirements. The optimizer 328 will return an optimal solution 330, represented in substitute proposals, and this solution will be provided to an optimal solution translator 332. The optimal solution translator 332 receives translation rules 334 from the set 318, and returns an optimal solution 336.

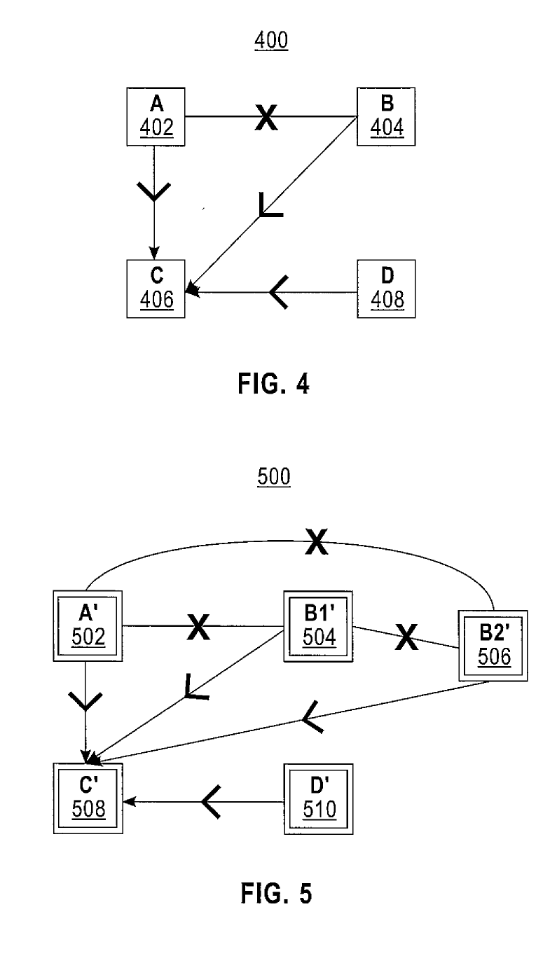

FIGS. 4-8 illustrate activity flows in an exemplary analysis and optimization of project proposals according to one or more embodiments of the present invention. In the example presented, A, B, C, and D, are four development proposals for enhancing customer satisfaction of a sales force automation product. The proposals can be implemented individually or jointly according to a specified set of constraints. FIG. 4 illustrates a diagram 400, showing proposal A (402), proposal B (404) proposal C (406), and proposal D (408). The objective is to increase maximum customer satisfaction, and constraints are as follows:
Budget: equal to or less than $10,000
Logical dependencies
Resource dependencies
Available staff experienced in J2EEE: 4
Available staff experienced in DOJO: 1
Available staff experienced in FusionCharts: 2

Relevant attributes of the proposals are as follows:

| | Imple- | Customer | | | |
|---|---|---|---|---|---|
| | mentation | Satisfaction | J2EE | DOJO | FusionCharts |
| | Cost (k$) | Increase | Staff | Staff | Staff |
| A: Integrate | 8 | 3% | 1 | 0 | 0 |
| 3^{rd} party | | | | | |
| dashboard | | | | | |
| tool | | | | | |
| B: Develop | 4 | 3% | 2 | 2 | 2 |
| native sales | | | | | |
| dashboard | | | | | |
| C: Develop | 2 | 1% | 1 | 0 | 0 |
| data | | | | | |
| statistics | | | | | |
| model | | | | | |
| D: Develop | 3 | 2% | 1 | 1 | 0 |
| prediction | | | | | |
| module | | | | | |

FIG. 4 illustrates relationships between the different proposals. Proposal A (402) and proposal B (404) are mutually exclusive. Proposals A (402), B (404), and D (408) all require proposal C.

FIG. 5 illustrates a diagram of a new proposal set including substitute proposals, and their relationships. The proposal set includes A′ (502), B1′ (504), B2′ (506), C′ (508) and D′ (510). The proposal A′ (502) has an exclude relationship with the proposals B1′ (504) and B2′ (506), and the proposals A′ (502), B1′ (504), B2′ (506), and D′ (510) all require C′ (508).

Relevant attributes of the proposals are as follows:

| | Imple- | Customer | | | |
|---|---|---|---|---|---|
| | mentation | Satisfaction | J2EE | DOJO | FusionCharts |
| | Cost (k$) | Increase | Staff | Staff | Staff |
| A′: Integrate | 8 | 3% | 1 | 0 | 0 |
| 3^{rd} party | | | | | |
| dashboard | | | | | |
| tool | | | | | |
| B1′: Develop | 4 | 3% | 2 | 2 | 0 |
| native sales | | | | | |
| dashboard | | | | | |
| using DOJO | | | | | |
| B2′: Develop | 4 | 3% | 2 | 0 | 2 |
| native sales | | | | | |
| dashboard | | | | | |
| using | | | | | |
| FusionCharts | | | | | |
| C′: Develop | 2 | 1% | 1 | 0 | 0 |
| data | | | | | |
| statistics | | | | | |
| model | | | | | |
| D′: Develop | 3 | 2% | 1 | 1 | 0 |
| prediction | | | | | |
| module | | | | | |

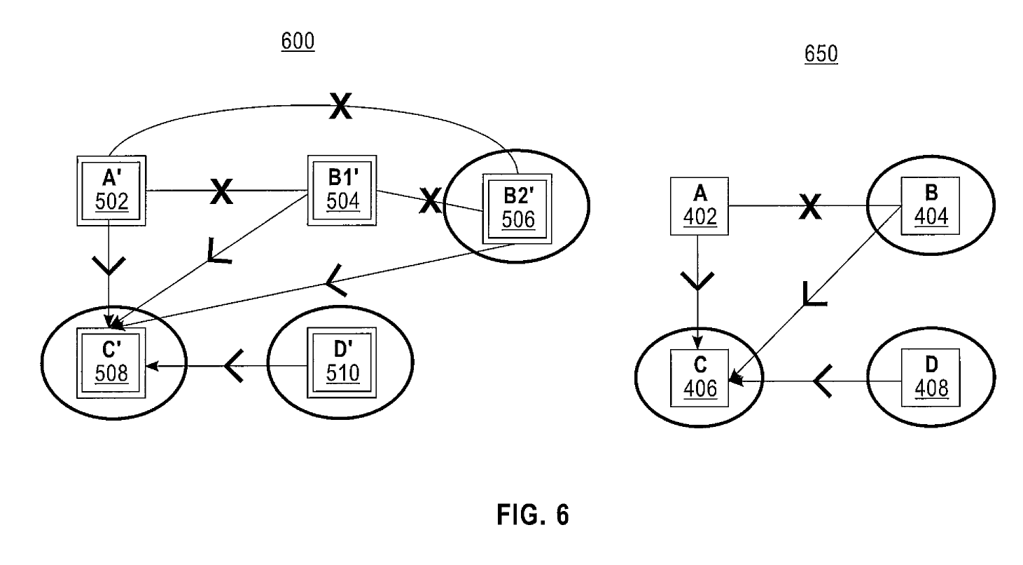

The substitute proposals illustrated in FIG. 5 and discussed above are provided as inputs to an optimizer, which yields outputs illustrated in FIG. 6, which shows that the optimizer has selected the proposals B2′ (506), C′ (508), and D′ (510). FIG. 6 further illustrates a diagram 650, showing translation of the optimized solution to an optimized solution based on the original proposals 402, 404, 406, and 408. In the final optimized solution, the proposals B (404), C (406), and D (408) have been selected.

The optimized solution attributes are presented below:

| | Imple- | Customer | | | |
|---|---|---|---|---|---|
| | mentation | Satisfaction | J2EE | DOJO | FusionCharts |
| | Cost (k$) | Increase | Staff | Staff | Staff |
| B: Develop | 4 | 3% | 2 | 0 | 2 |
| native sales | | | | | |
| dashboard | | | | | |
| C: Develop | 2 | 1% | 1 | 0 | 0 |
| data | | | | | |
| statistics | | | | | |
| model | | | | | |
| D: Develop | 3 | 2% | 1 | 1 | 0 |
| prediction | | | | | |
| module | | | | | |

The optimized solution selects development of a native sales dashboard, and this choice excludes integration of a third party dashboard tool. The specific implementation of the development of the native sales dashboard is the development using FusionCharts. Thus, the table above does not include proposal A, and proposal B requires 2 J2EE staff and 2 FusionCharts staff. The statistics for the solution are as follows:
Budget: $9,000
Total customer satisfaction increase: 6%
Available staff experienced in J2EE: 4
Available staff experienced in DOJO: 0
Available staff experienced in FusionCharts: 2

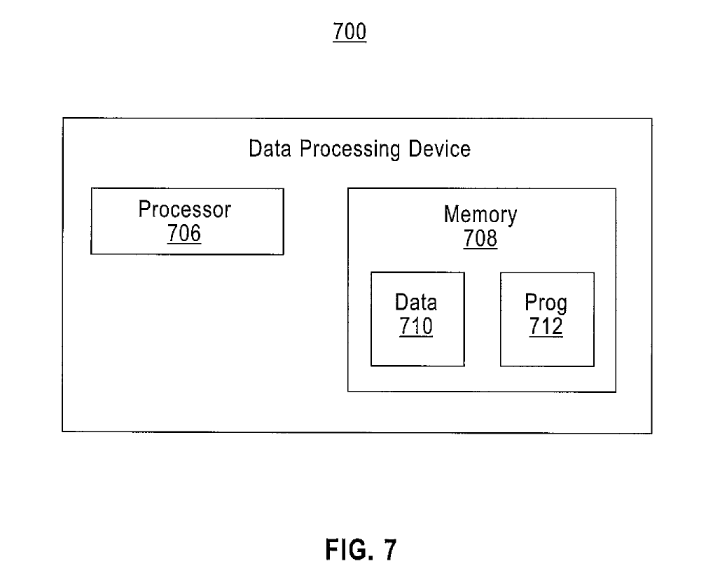

Reference is now made to FIG. 7 for illustrating a simplified block diagram of details of electronic a data processing device 700, which may be used to carry out one or more embodiments of the present invention.

The data processing device 700 includes a data processor (DP) 706, and a memory (MEM) 708 that stores data 710 and one or more programs (PROG) 712.

At least one of the PROGs 712 is assumed to include program instructions that, when executed by the associated DP, enable the electronic device to operate in accordance with the exemplary embodiments of this invention as was described above in detail.

In general, the exemplary embodiments of this invention may be implemented by computer software executable by the DP 706, or by hardware, or by a combination of software and/or firmware and hardware. The interactions between the major logical elements should be obvious to those skilled in the art for the level of detail needed to gain an understanding of the broader aspects of the invention beyond only the specific examples herein. It should be noted that the invention may be implemented with an application specific integrated circuit ASIC, a field programmable gated array FPGA, a digital signal processor or other suitable processor to carry out the intended function of the invention, including a central processor, a random access memory RAM, read only memory ROM, and communication ports for communicating between the various devices, units or terminals that incorporate combinations of such functions.

The MEM 708 may be of any type suitable to the local technical environment and may be implemented using any suitable data storage technology, such as semiconductor based memory devices, magnetic memory devices and systems, optical memory devices and systems, fixed memory and removable memory. The DP may be of any type suitable to the local technical environment, and may include one or more of general purpose computers, special purpose computers, microprocessors, digital signal processors (DSPs) and processors based on a multi-core processor architecture, as non-limiting examples.

At least one of the memories is assumed to tangibly embody software program instructions that, when executed by the associated processor, enable the electronic device to operate in accordance with the exemplary embodiments of this invention, as detailed by example above. As such, the exemplary embodiments of this invention may be implemented at least in part by computer software executable by the DP 706 of the data processing device 700 or by hardware, or by a combination of software and hardware.

Various embodiments of the present invention improve over the prior art by resolving a proposal allowing a choice of equivalent resource requirements and allowing for an optimization that allows for a selection between the equivalents.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

We claim:

1. An apparatus comprising:
at least one processor; and
at least one memory including computer program code,
wherein the at least one processor, in response to execution of the computer program code, is configured to cause the apparatus to perform at least the following:
for an original proposal directed toward achieving an objective, wherein the original proposal presents a choice between at least two equivalent sets of resource requirements, translating the proposal into a set of at least two substitute proposals, wherein the translation yields one proposal for each set of resource requirements;
performing optimization on a set of proposals including the set of substitute proposals, to yield an optimized solution, wherein the optimized solution is represented in terms including at least one of the substitute proposals; and
translating the optimized solution to a set of proposals taken from the original proposals.

2. The apparatus of claim 1, wherein the original proposal belongs to a set of at least a first and a second original proposal, and wherein the at least one of the first and second original proposals is translated into at least first and second substitute proposals.

3. The apparatus of claim 2, wherein the at least one processor, in response to execution of the computer program code, is further configured to cause the apparatus to further perform at least the following:
generating at least one relationship between at least two of the at least first and second substitute proposals, the first original proposal, and the second original proposal.

4. The apparatus of claim 3, wherein the at least one relationship is a require relationship.

5. The apparatus of claim 3, wherein the at least one relationship is an exclude relationship.

6. The apparatus of claim 3, wherein generating the at least one relationship is based on stored information relating to at least one logical dependency between the first and the second original proposals.

7. The apparatus of claim 2, wherein the at least one processor, in response to execution of the computer program code, is further configured to cause the apparatus to further perform at least the following:
for each of the at least the first and the second proposals having no equivalent resource requirements, generating a substitute proposal equivalent to the original proposal.

8. The apparatus of claim 2, wherein the at least one processor, in response to execution of the computer program code, is further configured to cause the apparatus to further perform at least the following:
for each of the at least the first and the second original proposals having an equivalent resource requirement, generating a set of substitute proposals comprising one set member for each of the equivalent resource requirements with attributes being calculated for each substitute proposal based on the original proposal attributes.

9. The apparatus of claim 8, wherein the at least one processor, in response to execution of the computer program code, is further configured to cause the apparatus to further perform at least the following:
for every two substitute proposals corresponding to the same original proposal, generating an exclude relationship between the substitute proposals.

10. The apparatus of claim 8, wherein the at least one processor, in response to execution of the computer program code, is further configured to cause the apparatus to further perform at least the following:
generating a require relationship between each pair of substitute proposals for which a require relationship exists between their original proposals.

11. The apparatus of claim 8, wherein the at least one processor, in response to execution of the computer program code, is further configured to cause the apparatus to further perform at least the following:
generating an exclude relationship between each pair of substitute proposals for which an exclude relationship exists between their original proposals.

12. The apparatus of claim 2, wherein the relationships between the substitute proposals are determined based at least in part on a set of translation rules.

13. An apparatus comprising:
at least one processor; and
at least one memory including computer program code,
wherein the at least one processor, in response to execution of the computer program code, is configured to cause the apparatus to perform at least the following:
for an original proposal directed toward achieving an objective, wherein the original proposal presents a choice between at least two equivalent sets of resource requirements, translating the proposal into a set of at least two substitute proposals, wherein the translation yields one proposal for each set of resource requirements; and
performing optimization on a set of proposals including the set of substitute proposals to yield an optimized solution, wherein the optimized solution is represented in terms including at least one of the substitute proposals.

14. A computer program product embodied on a non-transitory computer-readable medium, in which a computer program is stored which, when being executed by a computer, is configured to provide instructions to control or carry out at least the following:
for an original proposal directed toward achieving an objective, wherein the original proposal presents a choice between at least two equivalent sets of resource requirements, translating the proposal into a set of at least two substitute proposals, wherein the translation yields one proposal for each set of resource requirements;
performing optimization on a set of proposals including the set of substitute proposals, to yield an optimized solution, wherein the optimized solution is represented in terms including at least one of the substitute proposals; and
translating the optimized solution to a set of proposals taken from the original proposals.

15. The computer program product of claim 14, wherein the original proposal belongs to a set of at least a first and a second original proposal, and wherein the at least one of the first and second original proposals is translated into at least first and second substitute proposals.

16. The computer program product of claim 15, further configured to provide instructions to control or carry out at least the following:
generating at least one relationship between at least two of the at least first and second substitute proposals, the first original proposal, and the second original proposal.

17. The computer program product of claim 16, wherein the at least one relationship is a require relationship.

18. The computer program product of claim 16, wherein the at least one relationship is an exclude relationship.

19. The computer program product of claim 16, wherein the at least one relationship is generated based on stored information relating to at least one logical dependency between the first and the second original proposals.

20. The computer program product of claim 15, further configured to provide instructions to control or carry out at least the following:
for each of the at least the first and the second proposals having no equivalent resource requirements, generate a substitute proposal equivalent to the original proposal.
